(19) United States
(12) Patent Application Publication
(10) Pub. No.: US 2023/0151221 A1
(43) Pub. Date: May 18, 2023

(54) Storage-stable, multi-component reaction resin system and use of same

(71) Applicant: Hilti Aktiengesellschaft, Schaan (LI)

(72) Inventors: Memet-Emin KUMRU, Augsburg (DE); Thomas Bürgel, Landsberg (DE)

(73) Assignee: Hilti Aktiengesellschaft, Schaan (LI)

(21) Appl. No.: 17/754,584

(22) PCT Filed: Oct. 6, 2020
(86) PCT No.: PCT/EP2020/077988

§ 371 Date: Apr. 6, 2022

(30) Foreign Application Priority Data
Oct. 10, 2019 (WO) 19202355.4

(51) Int. Cl. C09D 4/00; C08F 220/34; C08F 222/10; C08K 3/36; C08K 5/14; C09D 133/14; C09D 135/02; C09D 7/20; C09D 7/61; C09D 7/63; F16B 25/00

(52) U.S. Cl. CPC C09D 4/00; C08F 220/343; C08F 222/102; C08K 3/36; C08K 5/14; C09D 133/14; C09D 135/02; C09D 7/20; C09D 7/61; C09D 7/63; F16B 25/0026; C08F 2800/20

(57) ABSTRACT

A multi-component reaction resin system for use with thread-forming screws contains a curable compound. In particular, the multi-component reaction resin system contains at least one radically curable compound and an inorganic filler in a first component, and contains a hardener for at least one radically curable reactive resin and water in a further second component. The inorganic filler has hydrophilic properties, and the reaction resin system is characterized by a low content of radically curable compounds that carry hydroxyl groups. The multi-component reaction resin system can be used with thread-forming screws.

The invention relates to a multi-component reaction resin system for use with thread-forming screws, which contains a curable compound, which in particular contains a radically curable compound and an inorganic filler in a first component and contains a hardener for the at least one radically curable reactive resin and water in a further second component.

Such reaction resin systems are used to fasten fastening elements in boreholes.

Various types of fastening elements for hard substrates, such as concrete, brickwork and the like, which are set into a borehole created beforehand in the substrate, are known.

Such fastening elements are set by means of rotating and/or striking, depending on the design.

A thread-forming screw for screwing into hard substrates, which has a shank as a main part and a screw head as an engagement means for a setting tool at one end of the shank, is known from EP 0 623 759 B1.

An internally threaded sleeve having a self-tapping thread is known from EP 1 536 149 A2.

An anchor rod that can be set by means of striking, which has a self-tapping thread on a shank as a main part, the height of which thread extends radially outward from the outer surface of the shank, and a machine thread adjacent thereto for fixing an object to the substrate, e.g. by means of a nut, is known from U.S. Pat. No. 4,350,464 A.

A disadvantage of the known solutions is that, due to the properties of the substrate and the type and condition of the tool for creating the borehole, the size of the annular gap between the outer surface of the main part and the borehole wall can vary greatly from fastening point to fastening point. In addition, high loads can act on the undercuts created by the thread in the substrate, which lead to a partial or—in the most extreme case—to a complete failure of the created fastening point, In order to avoid this and to achieve a high load-bearing capacity, fastening elements of this kind have a relatively long grip length of the thread in the substrate; however, this requires a great deal of effort to set the corresponding fastening element.

A screw having a self-tapping thread, which is set in a borehole filled beforehand with a curable compound, is known from DE 198 20 671 A1, DE 103 11 471 A1 or DE 10 2006 000 414 A1. The thread of this fastening element is anchored in the substrate and in the compound after the curable compound has cured.

Suitable curable materials, such as the two-component mortar based on epoxy known from DE 10002605 A1 or the two-component mortar based on radically curable compounds known from DE 3514031 A1, which are also known to a person skilled in the art, for example, as universal mortars, have a high filler content, which ensures high viscosity and low shrinkage behavior when the cured compound has a sufficient internal strength.

Another disadvantage of the solution according to DE 198 20 671 A1 is that the annular gap between the outer surface of the main part and the borehole wall must be of sufficient size so that curable compounds containing fillers can also be used in addition to low-viscosity compounds. To completely fill this annular gap, a large amount of the curable compound is therefore required.

The cartridge systems known for anchor rods, such as those known from EP 0 431 302 A2, EP 0 432 087 A1, EP 0 312 776 A1 or EP 0 638 705 A1, due to the very small annular gap, are not suitable for use with self-tapping screws because these cartridge systems either contain fillers that are too coarse-grained or the cartridges cannot be crushed using conventional thread-forming screws or the cartridges themselves produce particles that are too large even when crushed. Since only a few turns of the screw are possible in this application before the screw is set, it must be ensured that the curable compound is mixed quickly so that it cures reliably, which previously has not been possible with the known compounds.

If a conventional thread-forming screw is set in a borehole filled beforehand with a curable compound, the annular gap between the outer surface of the main part and the borehole wall is too small for most types of curable compounds, which are very highly filled with inorganic fillers. Thus, it is only possible to use low-viscosity, curable compounds, which are relatively expensive and have a lower strength compared to curable compounds containing fillers.

In the course of development, the inventors have found that it is possible, through the use of inorganic fillers which have hydrophilic properties, to provide a system that ensures quick and reliable mixing when using thread-forming screws and clean and safe handling when using thread-forming screws by virtue of the separate individual components having a very low viscosity, but the compound being stable immediately after mixing, i.e. having a correspondingly high viscosity. However, it has been found that problems with the storage stability of the component containing the radically curable compound occur when the radically curable compound has hydrophilic properties, which is the case in particular when the radically curable compound has free hydroxyl groups.

The problem addressed by the invention is therefore that of providing a multi-component reaction resin system for use in fastening a thread-forming screw, which not only makes it possible to ensure quick and reliable mixing when using thread-forming screws and also clean and safe handling when using thread-forming screws, but also to ensure a high level of storage stability of the reaction resin system.

This problem is solved by a multi-component reaction resin system according to claim 1.

According to the invention, a multi-component reaction resin system for use with thread-forming screws is provided, which contains a radically curable compound and an inorganic filler in a first component (resin component) and contains a hardener for the at least one radically curable reactive resin and water in a further second component (hardener component), which system is characterized in that the inorganic filler has hydrophilic properties and in that the proportion of radically curable compounds that carry hydroxyl groups is at most 10 wt. % of the total amount of radically curable compounds.

Without being bound by a specific theory, it is assumed that an interaction between the hydroxyl groups of the radically curable compound and the hydrophilic inorganic fillers results in the fillers losing their hydrophilic properties over the storage period and thus no longer being able to thicken the reaction resin system after mixing. Sedimentation of the fillers during storage and a decrease in the viscosity of the compound after mixing a reaction resin system stored for a longer period of time were observed.

In order to better understand the invention, the following explanations of the terminology used herein are considered to be useful. Within the meaning of the invention:
A “reaction resin mixture” is a mixture consisting of at least one reaction resin and/or at least one reactive diluent, whereby the mixture can optionally contain an accelerator and/or an inhibitor;
A “reaction resin based on a radically curable compound,” also called “reaction resin” or “base resin” for short, is a usually solid or high-viscosity “radically curable,” i.e. radically polymerizable, compound, which cures by means of polymerization and forms a resin matrix; the reaction resin is the reaction product of a bulk reaction per se; this also includes the reaction batch for producing the base resin after the reaction has ended, which is present without the product being isolated and therefore can contain the reaction resin, a reactive diluent, a stabilizer and a catalyst, if used, in addition to the radically curable compound;
“Reactive diluents” are liquid or low-viscosity monomers and oligomers which dilute the reaction resin and thereby give it the viscosity required for its application, contain one or more functional groups capable of reacting with the reaction resin and are predominantly constituents of the cured compound (resin matrix) during polymerization (curing);
An “inhibitor” is a compound capable of inhibiting the polymerization reaction (curing), which serves to avoid the polymerization reaction and thus an undesired premature polymerization of the reaction resin during storage (in this function often also referred to as a stabilizer) and/or to delay the start of the polymerization reaction immediately after adding the hardener; the role of the inhibitor depends on the quantities in which it is used;
“Hardeners” are substances that cause or initiate the polymerization (curing) of be radically curable compound, such as the reaction resin;
An “accelerator” is a compound capable of accelerating the polymerization reaction (curing), which serves to accelerate the formation of radicals, in particular from the hardener;
A “resin component” is a mixture consisting of the reaction resin and inorganic and/or organic aggregates (fillers and/or additives), such as an inhibitor and/or an accelerator;
A “hardener component” is a mixture consisting of the hardener and inorganic and/or organic aggregates (fillers and/or additives), such as a phlegmatizer, i.e. stabilizer for the hardener;
A “filler” is an organic or inorganic, in particular inorganic, compound that can be passive and/or reactive and/or functional; “passive” means that the compound is surrounded unchanged by the curing resin matrix; “reactive” means that the compound polymerizes into the resin matrix and forms an expanded network with the resin components; “functional” means that the compound is not polymerized into the resin matrix but fulfills a certain function in the formulation;
A “two-component reaction resin system” is a reaction resin system that comprises two components stored separately from one another, generally a resin component and a hardener component, so that the reaction resin cures only after the two components have been mixed;
A “multi-component reaction resin system” is a reaction resin system that comprises a plurality of components stored separately from one another, so that the reaction resin cures only after all components have been mixed;
“(Meth)acrylic . . . / . . . (meth)acrylic . . . ” means both the “methacrylic . . . / . . . methacrylic . . . ”

compounds and the “acrylic . . . / . . . acrylic . . . ” compounds; “methacrylic . . . / . . . methacrylic . . . ” compounds are preferred in the present invention;
“A” or “an” as the article preceding a class of chemical compounds, e.g. preceding the term “reactive diluent,” means that one or more compounds included in this class of chemical compounds, e.g. various “reactive diluents,” may be intended;
“At least one” means numerically “one or more”; in a preferred embodiment, this term numerically means “one”;
“Contain” and “comprise” mean that more constituents may be present in addition to the mentioned constituents; these terms are meant to be inclusive and therefore also include “consist of”; “consist of” is meant exclusively and means that no further constituents may be present; in a preferred embodiment, the terms “contain” and “comprise” mean the term “consist of”;
“Approximately” before a numerical value means a range of ±5% of this value, preferably ±2% of this value, particularly preferably ±0% of this value (i.e. exactly this value).

A first subject matter of the invention is the multi-component reaction resin system according to claim 1. Dependent claims 2 to 16 relate to preferred embodiments of this subject matter of the invention.

A second subject matter of the invention is the use according to claim 17. Dependent claim 18 relates to a preferred embodiment of this subject matter of the invention.

A first subject matter of the invention is accordingly a multi-component reaction resin system for use with thread-forming screws, which system contains at least one radically curable compound and an inorganic filler in a first component and a hardener for the radically curable compound and water in a further second component, the inorganic filler having hydrophilic properties, the reaction resin system being characterized in that the content of radically curable compound that carries hydroxyl groups is at most 10 wt. % of the total amount of radically curable compound.

The multi-component reaction resin system according to the invention comprises a resin component and a hardener component. The resin component contains at least one radically curable compound. The radically curable compound can be a reaction resin. Alternatively, the one radically curable compound can be a reactive diluent. According to a further alternative, the radically curable compound can also comprise a mixture consisting of at least one reaction resin and at least one reactive diluent, a reaction resin mixture.

Ethylenically unsaturated compounds, compounds which have carbon-carbon triple bonds, and thiol-yne/ene resins, as are known to a person skilled in the art, are suitable as radically curable compounds.

Particularly preferably, the radically curable compound, the reaction resin, is an unsaturated compound based on urethane (meth)acrylate, epoxy (meth)acrylate, a (meth)acrylate of an alkoxylated bisphenol or a compound based on further ethylenically unsaturated compounds.

Of these compounds, the group of ethylenically unsaturated compounds is preferred, which group comprises styrene and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are particularly suitable and are described, for example, in applications EP 1 935 860 A1, DE 195 31 649 A1, WO 02/051903 A1 and WO 10/108939 A1. Vinyl ester resins (synonym: (meth)acrylate resins) are in this case most preferred due to their hydrolytic resistance and excellent mechanical properties. Vinyl ester urethane resins, in particular urethane methacrylates, are very particularly preferred. These include, as preferred resins, the urethane methacrylate resins described in DE 10 2011 017 626 94. In this regard, DE 10 2011 017 626 B4, and above all its description of the composition of these resins, in particular in the examples of DE 10 2011 017 626 94, is incorporated herein by reference.

Examples of suitable unsaturated polyesters which can be used in the resin mixture are divided into the following categories, as classified by M. Malik et al. in J. M. S. —Rev. Macromol. Chem. Phys., C40 (2 and 3), p.139-165 (2000):
(1) Ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;
(2) Iso-resins: these are prepared from isophthalic acid, maleic anhydride or fumaric acid and glycols. These resins can contain higher proportions of reactive diluents than the ortho-resins;
(3) Bisphenol A fumarates: these are based on ethoxylated bisphenol A and fumaric acid;
(4) HET acid resins (hexachloroendomethylene tetrahydrophthalic acid resins): these are resins obtained from chlorine/bromine-containing anhydrides or phenols during the preparation of unsaturated polyester resins.

In addition to these resin classes, what are referred to as dicyclopentadiene resins (DCPD resins) can also be distinguished as unsaturated polyester resins. The class of DCPD resins is either obtained by modifying one of the above-mentioned resin types by means of a Diels-Alder reaction with cyclopentadiene, or said resins are alternatively obtained by means of a first reaction of a dicarboxylic acid, for example maleic acid, with dicyclopentadienyl and then by means of a second reaction of the usual preparation of an unsaturated polyester resin, the latter being referred to as a DCPD maleate resin.

The unsaturated polyester resin preferably has a molecular weight Mn in the range of 500 to 10,000 daltons, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as the unsaturated polyester resin, the acid value is preferably 0 to 50 mg KOH/g resin.

In the context of the invention, vinyl ester resins are oligomers, prepolymers or polymers having at least one (meth)acrylate end group, what are referred to as (meth)acrylate-functionalized resins, which also include urethane (meth)acrylate resins and epoxy (meth)acrylates.

Vinyl ester resins, which have unsaturated groups only in the end position, are obtained, for example, by reacting epoxy oligomers or polymers (for example bisphenol A digylcidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting an epoxy oligomer or polymer with methacrylic acid or methacrylamide, preferably with methacrylic acid, and optionally with a chain extender, such as diethylene glycol or dipropylene glycol. Examples of such compounds are known from applications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

Particularly suitable and preferred vinyl ester resins are (meth)acrylate-functionalized resins, which are obtained, for example, by reacting difunctional and/or higher-functional isocyanates with suitable acrylic compounds, optionally with the help of hydroxy compounds that contain at least two hydroxyl groups, as described for example in DE 3940309 A1. The urethane methacrylate resins (which are also referred to as vinyl ester urethane resins) described in DE 10 2011 017 626 B4 are more particularly suitable and preferred.

Aliphatic (cyclic or linear) and/or aromatic di- or higher-functional isocyanates or prepolymers thereof can be used as isocyanates. The use of such compounds serves to increase wettability and thus to improve the adhesive properties. Aromatic di- or higher-functional isocyanates or prepolymers thereof are preferred, with aromatic di- or higher-functional prepolymers being particularly preferred. By way of example, toluylene diisocyanate (TDI), diisocyanatodiphenylmethane (MDI) and polymeric diisocyanatodiphenylmethane (pMDI) to increase chain stiffening and hexane diisocyanate (HDI) and isophorone diisocyanate (IPDI), which improve flexibility, may be mentioned, among which polymeric diisocyanatodiphenylmethane (pMDI) is particularly preferred.

Suitable acrylic compounds are acrylic acid and acrylic acids substituted on the hydrocarbon group, such as methacrylic acid, hydroxyl group-containing esters of acrylic or methacrylic acid with polyvalent alcohols, pentaerythritol tri(meth)acrylate, glycerol di(meth)acrylate, such as trimethylolpropane di(meth)acrylate, neopentyl glycol mono(meth)acrylate. Acrylic or methacrylic acid hydroxyalkyl esters, such as hydroxyethyl (meth)acrylate, hydroxypropyl (meth)acrylate, polyoxyethylene (meth)acrylate, polyoxypropylene (meth)acrylate, are preferred, especially since such compounds serve to sterically prevent the saponification reaction. Because of its lower alkali stability, acrylic acid is less preferred than acrylic acids substituted on the hydrocarbon group.

Hydroxy compounds that can optionally be used are suitable di- or higher-valent alcohols, for example derivative products of ethylene oxide or propylene oxide, such as ethanedial, di- or triethylene glycol, propanediol, dipropylene glycol, other dials, such as 1,4-butanediol, 1,6-hexanediol, neopentyl glycol, diethanolamine, further bisphenol A or F or their ethoxylation/propoxylation and/or hydrogenation or halogenation products, higher-valent alcohols, such as glycerol, trimethylolpropane, hexanetriol and pentaerythritol, hydroxyl group-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl group-containing polyesters based on the above-mentioned alcohols or polyethers and dicarboxylic acids or their anhydrides, such as adipic acid, phthalic acid, tetra- or hexahydrophthalic acid, HET acid, maleic acid, furnaric acid, itaconic acid, sebacic acid and the like. Particularly preferred are hydroxy compounds having aromatic structural units for reinforcing the chain of the resin; hydroxy compounds containing unsaturated structural units, such as fumaric acid, for increasing the crosslinking density; branched or star-shaped hydroxy compounds, in particular tri- or higher-valent alcohols and/or polyethers or polyesters, which contain the structural units thereof; branched or star-shaped urethane (meth)acrylates for achieving lower viscosity of the resins or solutions thereof in reactive diluents and higher reactivity and crosslinking density.

The vinyl ester resin preferably has a molecular weight Mn in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

All of these resins can be modified according to methods known to a person skilled in the art, for example to achieve lower acid numbers, hydroxide numbers or anhydride numbers, or can be made more flexible by introducing flexible units into the backbone, and the like.

In addition, the resin may contain other reactive groups that can be polymerized with a radical initiator, such as peroxides, for example reactive groups derived from itaconic acid, citraconic acid and allylic groups and the like.

The resins described in the examples are preferred.

In one embodiment, the resin component of the reaction resin system contains, in addition to the reaction resin, at least one further low-viscosity, radically polymerizable compound as the reactive diluent. This is expediently added to the reaction resin and is therefore contained in the resin component.

Suitable, in particular low-viscosity, radically curable compounds as reactive diluents are described in applications EP 1 935 860 A1 and DE 195 31 649 A1. The reaction resin system preferably contains a (meth)acrylic acid ester as a reactive diluent, and the following (meth)acrylic acid esters can particularly preferably be used; hydroxyalkyl (meth)acrylates such as hydroxypropyl (meth)acrylate, 2-hydroxyethyl (meth)acrylate; alkanediol (meth)acrylates such as ethanediol-1,2-di(meth)acrylate, propanediol-1,3-di(meth)acrylate, butanediol-1,2-di(meth)acrylate, butanediol-1,3-di(meth)acrylate, butanediol-1,4-di(meth)acrylate, hexanediol-1,6-di(meth)acrylate, 2-ethylhexyl (meth)acrylate, phenylethyl (meth)acrylate, tetrahydrofurfuryl (meth)acrylate; trimethylolpropane tri(meth)acrylate; ethyl triglycol (meth)acrylate; N,N-dimethylaminoethyl (meth)acrylate; N,N-dimethylaminomethyl (meth)acrylate; acetoacetoxyethyl (meth)acrylate; alkylene (meth)acrylates such as ethylene and diethylene glycol di(meth)acrylate; oligo- and polyalkylene glycol di(meth)acrylates such as PEG200 di(meth)acrylate; methoxy polyethylene glycol mono(meth)acrylate; trimethylcyclohexyl (meth)acrylate; dicyclopentenyloxyethyl (meth)acrylate; tricyclopentadienyl di(meth)acrylate; dicyclopentenyloxyethyl crotonate; bisphenol A (meth)acrylate; novolac epoxy di(meth)acrylate; di-[(meth)acryloyl-maleoyl]-tricyclo-5.2.1.0.^{2.6}-decane; 3-(meth)acryloyl-oxymethyl-tricylo-5.2.1.0.^{2.6}-decane; 3-(meth)cyclopentadienyl (meth)acrylate; isobornyl (meth)acrylate; decalyl-2-(meth)acrylate; tetrahydrofurfuryl (meth)acrylate; and alkoxylated tri-, tetra- and pentamethylacrylates.

The reactive diluent can be used alone or as a mixture consisting of two or more reactive diluents.

The reaction resin system preferably contains, as a reactive diluent, a (meth)acrylic acid ester which does not carry a hydroxyl group, and is selected from the group consisting of 2-ethylhexyl (meth)acrylate, phenylethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate, acetoacetoxyethyl (meth)acrylate, di-[(meth)acryloyl-maleoyl]-tricyclo-5.2.1.0.^{2.6}-decane, 3-(meth)acryloyl-oxymethyl-tricylo-5.2.1.0.^{2.6}-decane, 3-(meth)cyclopentadienyl (meth)acrylate, methoxypolyethylene glycol mono(meth)acrylate, trimethylcyclohexyl (meth)acrylate, dicyclopentenyloxyethyl (meth)acrylate, bisphenol A (meth)acrylate, isobornyl (meth)acrylate, decalyl-2-(meth)acrylate, ethanediol-1,2-di(meth)acrylate, propanediol-1,3-di(meth)acrylate, butanediol-1,2-di(meth)acrylate, butanediol-1,3-di(meth)acrylate, butanediol-1,4-di(meth)acrylate, hexanediol-1,6-di(meth)acrylate, ethylene-, diethylene glycol di(meth)acrylate, PEG200 di(meth)acrylate, tricyclopentadienyl di(meth)acrylate, novolac epoxy di(meth)acrylate, trirriethylolpropane tri(meth)acrylate and dicyclopentenyloxyethyl crotonate.

In principle, other conventional radically polymerizable compounds, alone or in a mixture with the (meth)acrylic acid esters described in the preceding paragraph, can also be used, e.g. styrene, α-methylstyrene, alkylated styrenes, such as tert-butylstyrene, divinylbenzene and vinyl and allyl compounds. Examples of vinyl or allyl compounds of this kind are ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, adipic acid divinyl ester, trimethylolpropane diallyl ether and trimethylolpropane triallyl ether.

The radically curable compound can be contained in the reaction resin system in an amount of 10 to 99.99 wt. %, preferably 15 to 97 wt. %, particularly preferably 30 to 95 wt. %, based on the resin component. The radically curable compound can be either a reaction resin based on a radically curable compound or a reactive diluent or a mixture of a reaction resin with two or more reactive diluents.

In cases where the radically curable compound is a reaction resin mixture, the amount of the mixture which can be contained in the reaction resin system corresponds to the amount of the radically curable compound, specifically from 10 to 99.99 wt. %, preferably 15 to 97 wt. %, particularly preferably 30 to 95 wt. %, based on the resin component, and, based on the reaction resin mixture, the proportion of the reaction resin is 0 to 100 wt. %, preferably 30 to 65 wt. %, and the proportion of the reactive diluent or a mixture consisting of a plurality of reactive diluents is 0 to 100 wt. %, preferably 35 to 70 wt. %.

According to the invention, the proportion of radically curable compounds that carry hydroxyl groups is at most 10 wt. %, preferably at most 5 wt. % and particularly preferably at most 1 wt. % of the total amount of radically curable compounds. It is particularly preferred for no radically curable compounds that carry hydroxyl groups to be contained. In cases where the radically curable compound contains a radically curable compound that carries hydroxyl groups, for example due to the production process, the proportion of radically curable compound that carries hydroxyl groups must be reduced accordingly by adding at least one compound that carries no hydroxyl groups.

The total amount of the radically curable compound depends on the degree of filling, i.e. the amount of inorganic fillers, including the fillers listed below, in particular the hydrophilic fillers, the further inorganic aggregates and the hydraulically setting or polycondensable compounds.

According to the present invention, the inorganic filler used is one which has hydrophilic properties. Hydrophilic properties mean that the fillers interact with water or can react with water. This ensures that immediately after mixing the resin component and the water-containing hardener component, the resulting compound becomes so viscous that it becomes stable and thus no longer leaks out of the borehole, which is particularly advantageous for overhead fastenings or wall fastenings. The viscosity is so high that even if the screw is unscrewed immediately after the screw has been set, if the compound has not yet cured or has not cured completely, the compound will not be sprayed by the rotational movement of the screw.

The surfaces in particular of the inorganic fillers used, but also the inner regions, can have hydrophilic properties. In particular, the surfaces of the inorganic fillers can be modified by means of hydrophilic coatings, primers or seals.

Examples of inorganic fillers having hydrophilic properties include those of which the surface is treated with a hydrophilic surface treatment agent. Examples of such hydrophilic surface treatment agents include, inter alia, silane surface treatment agents, titanate surface treatment agents, aluminum surface treatment agents, zirconium aluminate surface treatment agents, Al₂O₃, TiO₂, ZrO₂, silicone and aluminum stearate, among which a silane surface treatment agent is preferred.

According to a further, preferred embodiment of the multi-component reaction resin system according to the invention, the inorganic filler comprises minerals, selected from a group consisting of alkaline earth metals and their salts, bentonite, carbonates, silicas. silica gel, salts of alkaline earth metals with silica and silicates, in particular silicas.

The inorganic filler can be produced by a dry method such as vapor deposition or combustion, or by a wet method such as precipitation. A commercially available product can also be used. Taking into consideration the rheological properties of the reaction resin system, the hydrophilic inorganic filler is preferably a fine filler having a surface area of more than 80 m²/g, preferably more than 150 m²/g and more preferably between 150 and 400 m²/g.

According to a further, preferred embodiment of the multi-component reaction resin system according to the invention, the inorganic filler comprises a silicon oxide-based filler.

According to a further, particularly preferred embodiment of the multi-component reaction resin system according to the invention, the inorganic filler comprises a silica.

The silica is not limited to a particular type or its manufacture. The silica can be a natural or a synthetic silica.

The silica is preferably an amorphous silica which is selected from the group consisting of colloidal silica, wet-chemically produced silicas such as precipitated silicas, silica gels, silica sols, fumed or thermally produced silicas which are produced, e.g. in an electric arc, plasma or by flame hydrolysis, silica smoke, silica glass (quartz glass), silica material (quartz material) and skeletons of radiolarians and diatoms in the form of diatomaceous earth.

The proportion of the hydrophilic inorganic filler depends on the desired properties of the multi-component reaction resin system. The hydrophilic inorganic filler is preferably used in an amount of 0.01 to 15 wt. %, more preferably 0.1 to 10 wt. % and particularly preferably in the range of 1 to 7 wt. %, based in each case on the resin component.

The reaction resin system preferably does not contain any further fillers.

However, it cannot be ruled out that the reaction resin system may contain further fillers. This is especially true if the properties of the reaction resin system have to be adapted.

According to one embodiment, the resin component therefore contains further, different inorganic additives, such as fillers and/or further additives.

The fillers used are conventional fillers, preferably mineral or mineral-like fillers, such as quartz, glass, sand, quartz sand, quartz powder, porcelain, corundum, ceramics, talc, silica (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g., alumina cement or Portland cement), metals such as aluminum, carbon black, and also wood, mineral or organic fibers, or the like, or mixtures of two or more thereof, which can be added as powder, in the form of granules or in the form of shaped bodies. The fillers may be present in any desired forms, for example as powder or flour, or as shaped bodies, for example in cylindrical, annular, spherical, platelet, rod, saddle or crystal form, or else in fibrous form (fibrillar fillers), and the corresponding base particles preferably have a maximum diameter of 10 mm. However, the globular, inert substances (spherical form) have a preferred and more pronounced reinforcing effect.

The further fillers are preferably present in the resin component in such an amount that the total amount of the fillers, i.e. the total amount of the hydrophilic filler and the further fillers, is from 0.01 to 90, in particular 0.01 to 60, especially 0.01 to 50 wt. %, based in each case on the resin component.

Further conceivable additives are also rheological additives, such as optionally organically after-treated fumed silica, bentonites, alkyl- and methylcelluloses, castor oil derivatives or the like, plasticizers, such as phthalic or sebacic acid esters, stabilizers, antistatic agents, thickeners, flexibilizers, curing catalysts, rheology aids, wetting agents, coloring additives, such as dyes or in particular pigments, for example for different staining of the components for improved control of the mixing thereof, or the like, or mixtures of two or more thereof. Non-reactive diluents (solvents) such as low-alkyl ketones, e.g. acetone, di-low-alkyl low-alkanoyl amides such as dimethylacetamide, low-alkylbenzenes such as xylenes or toluene, phthalic acid esters or paraffins, or water can also be present, preferably in an amount of up to 30 wt. %, based on the particular component (resin component, hardener component), for example from 1 to 20 wt. %.

In a further embodiment of the invention, in addition to the radically curable compound, the resin component also contains a hydraulically setting or polycondensable inorganic compound, in particular cement. Such hybrid mortar systems are described in detail in DE 42 31 161 A1. In this case, the resin component preferably contains, as a hydraulically setting or polycondensable inorganic compound, cement, for example Portland cement or aluminate cement, with cements which are free of transition metal oxide or have a low level of transition metal being particularly preferred. Gypsum can also be used as a hydraulically setting inorganic compound as such or in a mixture with the cement. The resin component may also comprise silicatic, polycondensable compounds, in particular soluble, dissolved and/or amorphous-silica-containing substances such as fumed silica, as the polycondensable inorganic compound.

The reaction resin system can contain the hydraulically setting or polycondensable compound in an amount of 0 to 30 wt. %, preferably 1 to 25 wt. %, particularly preferably 5 to 20 wt. %, based on the resin component.

In a further embodiment, the reaction resin system also contains at least one accelerator. This accelerates the curing reaction.

Suitable accelerators are known to a person skilled in the art. These are expediently amines.

Suitable amines are selected from the following compounds, which are described in application US 2011071234 A1, for example: dimethylamine, trimethylamine, ethylamine, diethylamine, triethylamine, n-propylamine, di-n-propylamine, tri-n-propylamine, iso-propylamine, di-iso-propylamine, tri-iso-propylamine, n-butylamine, iso-butylamine, tert-butylamine, di-n-butylamine, di-iso-butylamine, tri-iso-butylamine, pentylamine, iso-pentylamine, di-iso-pentylamine, hexylamine, octylamine, dodecylamine, laurylamine, stearylamine, aminoethanol, diethanolamine, triethanolamine, aminohexanol, ethoxyaminoethane, dimethyl(2-chloroethyl)amine, 2-ethylhexylamine, bis(2-chloroethyl)amine, 2-ethylhexylamine, bis(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis(2-hydroxyethyl)oleylamine, tris[2(2-hydroxyethoxy)ethyl]amine, 3-amino-1-propanol, methyl(3-aminopropyl)ether, ethyl-(3-aminopropyl)ether, 1,4-butanediol-bis(3-arninopropyl ether), 3-dimethylamino-1-propanol, 1-amino-2-propanol, 1-diethylamino-2-propanol, di-iso-propanolamine, methyl-bis(2-hydroxypropyl)amine, tris(2-hydroxypropyl)amine, 4-amino-2-butanol, 2-amino-2-methylpropanol, 2-amino-2-methylpropanediol, 2-amino-2-hydroxymethylpropanediol, 5-diethylamino-2-pentanone, 3-methylaminopropionitrile, 6-aminohexanoic acid, 11-aminoundecanoic acid, 6-aminohexanoic acid ethyl ester, 11-aminohexanoic acid isopropyl ester, cyclohexylamine, N-methylcyclohexylamine, N,N-dimethylcyclohexylarnine, dicyclohexylamine, N-ethylcyciohexylamine, N-(2-hydroxyethyl)cyclohexylamine, N,N-bis(2-hydroxyethyl)cyclohexylamine, N-(3-aminopropyl)cyclohexylamine, aminomethylcyclohexane, hexahydrotoluidine, hexahydrobenzylamine, aniline, N-methylaniline, N,N-dimethylaniline, N,N-diethylaniline, N,N-di-propylaniline, iso-butylaniline, toluidines, diphenylamine, hydroxyethylaniline, bis(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, di-iso-propylaniline, dodecylaniline, aminonaphthalene, N-methylaminonaphthalene, N,N-dimethylaminonaphthalene, N,N-dibenzyinaphthalene, diaminocyclohexane, 4,4′-diamino-dicyclohexylmethane, diamino-dimethyl-dicyclohexylmethane, phenylenediamine, xylylenediamine, diaminobiphenyl, naphthalenediamines, benzidines, 2,2-bis(aminophenyl)propane, aminoanisoles, aminothiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are aniline derivatives, toluidine derivatives and N,N-bisalkylarylamines, such as N,N-dimethylaniline, N,N-diethylaniline, toluidine, N,N-bis(hydroxyalkyl)arylamines, N,N-bis(2-hydroxyethyl)aniline, N,N-bis(2-hydroxyethyl)toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine and 4,4′-bis(dimethylamino)diphenylmethane,

Polymeric amines, such as those obtained by polycondensation of N,N-bis(hydroxyalkyl)aniline with dicarboxylic acids or by polyaddition of ethylene oxide and these amines, are also suitable as accelerators.

Preferred accelerators are N,N-bis(2-hydroxypropyl)toluidine, N,N-bis(2-hydroxyethyl)toluidine and para-toluidine ethoxylate (Bisomer® PTE).

The reaction resin system can contain the accelerator in an amount of 0 to 10 wt. %. preferably 0.01 to 5 wt. %, particularly preferably 0.5 to 3 wt. %, based on the resin component. If a plurality of accelerators is contained, the amount just mentioned corresponds to the total amount of accelerators.

In yet a further embodiment, the resin component also contains an inhibitor both for the storage stability of the reaction resin and the resin component and for adjusting the gel time. The reaction resin system can contain the inhibitor alone or together with the accelerator. A suitably coordinated accelerator-inhibitor combination is preferably used to adjust the processing time or gel time.

Suitable inhibitors are those commonly used for radically polymerizable compounds, as known to a person skilled in the art. The inhibitors are preferably selected from phenolic compounds and non-phenolic compounds, such as stable radicals and/or phenothiazines.

Suitable phenolic inhibitors are phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, pyrocatechol and butylpyrocatechols such as 4-tert-butylpyrocatechol. 4,6-di-tert-butylpyrocatechol, hydroquinones such as hydroquinone, 2-methyihydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof.

Phenothiazines, such as phenothiazine and/or derivatives or combinations thereof, or stable organic radicals, such as galvinoxyl radicals and N-oxyl radicals, are preferably taken into consideration as non-phenolic or anaerobic inhibitors, i.e. inhibitors that are active even without oxygen, in contrast with the phenolic inhibitors.

Examples of N-oxyl radicals that can be used are those described in DE 199 56 509. Suitable stable N-oxyl radicals (nitroxyl radicals) can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxy-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine and diethylhydroxylamine. Further suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl)oxime and the like.

These compounds are particularly useful and mostly necessary because otherwise the desired storage stability of preferably more than 3 months, in particular 6 months or more, cannot be achieved. The UV stability and in particular the storage stability can be increased considerably in this way.

Furthermore, pyrimidinoi or pyridinol compounds substituted in para-position to the hydroxyl group, as described in patent DE 10 2011 077 248 B1, can be used as inhibitors.

Preferred inhibitors are 1-oxyl-2,2,6,6-tet amethylpiperidine (TEMPO) and 1-oxyl-2,2,6,6-tetramethylpiperidin-4-ol (TEMPOL), catechols, particularly preferably Cert-butyl-pyrocatechol and pyrocatechol the desired properties are achieved by means of the functional group (compared to the reactive diluents otherwise used), BHT and phenothiazine.

The inhibitors can be used either alone or as a combination of two or more thereof, depending on the desired properties of the reaction resin system. The combination of the phenolic and the non-phenolic inhibitors allows a synergistic effect, as is also shown by the setting of a substantially drift-free adjustment of the gel time of the reaction resin composition.

The reaction resin system can contain the inhibitor in an amount of 0 to 5 wt. %, preferably 0.001 to 3 wt. %, particularly preferably 0.01 to 1 wt. %, based on the resin component. If a plurality of inhibitors is contained, the amount just mentioned corresponds to the total amount of inhibitors.

The curing of the radically curable compound is expediently initiated using a peroxide as a hardener. In addition to the peroxide, an accelerator can also be used as described above. Any of the peroxides known to a person skilled in the art that are used to cure methacrylate resins can be used. Such peroxides include organic and inorganic peroxides, either liquid or solid, and it is also possible to use hydrogen peroxide.

Examples of suitable peroxides are peroxycarbonates (of formula —OC(O)OO—), peroxyesters (of formula —C(O)OO—), diacyl peroxides (of formula —C(O)OOC(O)—), dialkyl peroxides (of formula —OO—) and the like. These may be present as oligomers or polymers. A comprehensive set of examples of suitable peroxides is described, for example, in application US 2002/0091214 A1, paragraph [0018].

The peroxides are preferably selected from the group of organic peroxides. Suitable organic peroxides are: tertiary alkyl hydroperoxides such as tert-butyl hydroperoxide and other hydroperoxides such as cumene hydroperoxide, peroxyesters or peracids such as tert-butyl peresters (e.g. tert-butyl peroxybenzoate), benzoyl peroxide, peracetates and perbenzoates, lauroyl peroxide including (di)peroxyesters, perethers such as peroxy diethyl ether, perketones such as methyl ethyl ketone peroxide. The organic peroxides used as curing agents are often tertiary peresters or tertiary hydroperoxides, i.e. peroxide compounds having tertiary carbon atoms which are bonded directly to an —O—O-acyl or —OOH group. However, mixtures of these peroxides with other peroxides can also be used according to the invention. The peroxides may also be mixed peroxides, i.e. peroxides which have two different peroxide-carrying units in one molecule. Preferably, benzoyl peroxide (BPO) or Cert-butyl peroxybenzoate is used for curing.

In addition to the peroxide, according to the invention the hardener component also contains water as a phlegmatizer. In addition to the water, the hardener component can also contain further phlegmatizers, with water being preferred as the sole phlegmatizer in order not to introduce any compounds which have a softening effect.

The peroxide is preferably present as a hardener together with the water as a suspension. Corresponding suspensions are commercially available in different concentrations, such as, for example, the aqueous dibenzoyl peroxide suspensions from United Initiators (BP40SAQ or BP20SAQ). Perkadox 40L-W (from Nouryon), Luperox® EZ-FLO (from Arkema), Peroxan BP40W (from Pergan).

The reaction resin system can contain the peroxide in an amount of 2 to 50 wt. %, preferably 5 to 45 wt. %, particularly preferably 10 to 40 wt. %, based on the hardener component.

In addition to water and the hardener, commercial peroxide dispersions contain emulsifiers, antifreeze agents, buffers and rheological additives in undisclosed types and amounts.

In addition, the hardener component can also contain further additives, specifically emulsifiers, antifreeze agents, buffers and/or rheological additives, and/or fillers.

Suitable emulsifiers are; ionic, nonionic or amphoteric surfactants; soaps, wetting agents, detergents; polyalkylene glycol ethers; salts of fatty acids, mono- or diglycerides of fatty acids, sugar glycerides, lecithin; alkanesulfonates, alkylbenzenesulfonates, fatty alcohol sulfates, fatty alcohol polyglycol ethers, fatty alcohol ether sulfates, sulfonated fatty acid methyl esters; fatty alcohol carboxylates; alkyl polyglycosides, sorbitan esters, N-methyl glucamides, sucrose esters; alkyl phenols, alkyl phenol polyglycol ethers, alkyl phenol carboxylates; quaternary ammonium compounds, esterquats, carboxylates of quaternary ammonium compounds.

Suitable antifreeze agents are: organic or inorganic, water-soluble additives that lower the freezing temperature of the water; mono-, bi- or higher-functional alcohols such as ethanol, n- or iso-propanol, n-, iso- or tert-butanol, etc.; ethylene glycol, 1,2- or 1,3-propylene glycol, glycerol, trimethylol propane, etc., oligo- or polyglycols such as dialkylene glycols, trialkylene glycols, etc.; sugars, especially mono- or disaccharides; trioses, tetroses, pentoses and hexoses in their aldehyde or keto form, and the analogous sugar alcohols. Examples include, but are not limited to, glyceraldehyde, fructose, glucose, sucrose, mannitol, etc.

Suitable buffers are organic or inorganic acid/base pairs that stabilize the pH of the hardener component, such as acetic acid/alkali acetate, citric acid/monoalkali citrate, monoalkali/dialkali citrate, dialkali/trialkali citrate, combinations of mono-, di- and/or tri-basic alkali phosphates, optionally with phosphoric acid; ammonia with ammonium salts;

carbonic acid-bicarbonate buffers, etc. Intramolecular, so-called good buffers can also be used, such as 4-(2-hydroxyethyl)-1-piperazineethanesulfonic acid (HEPES) or 2-(N-morpholino)ethanesulfonic acid (MES) as well as tris(hydroxymethyl)-aminomethane (TRIS), etc.

The flow properties are adjusted by adding thickening substances, also known as rheological additives. Suitable rheological additives are: phyllosilicates such as laponites, bentones or montmorillonite, Neuburg siliceous earth, fumed silicas, polysaccharides; polyacrylate, polyurethane or polyurea thickeners and cellulose esters. Wetting agents and dispersants, surface additives, defoamers & deaerators, wax additives, adhesion promoters, viscosity reducers or process additives can also be added for optimization.

The fillers used are conventional fillers, preferably mineral or mineral-like fillers, such as quartz, glass, sand, quartz sand, quartz powder, porcelain, corundum, ceramics, talc, silica (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g. alumina cement or Portland cement), metals such as aluminum, carbon black, and also wood, mineral or organic fibers, or the like, or mixtures of two or more thereof, which can be added as powder, in the form of granules or in the form of shaped bodies. The fillers may be present in any desired forms, for example as powder or flour, or as shaped bodies, for example in cylindrical, annular, spherical, platelet, rod, saddle or crystal form, or else in fibrous form (fibrillar fillers), and the corresponding base particles preferably have a maximum diameter of 10 mm. However, the globular, inert substances (spherical form) have a preferred and more pronounced reinforcing effect.

The fillers are preferably present in the particular component in an amount of up to 80, in particular 0 to 60, above all 0 to 50 wt. %.

The sum of the additives not already contained in the commercial products can be from 0 to 30, preferably from 0 to 25, particularly preferably from 0 to 20 wt. %, based in each case on the hardener component.

In a preferred embodiment of the invention, the hardener component also contains a rheological additive based on a phyllosilicate, in particular an activated or swellable phyllosilicate. The swellable phyllosilicate is particularly preferably a magnesium aluminum silicate or a sodium aluminum silicate.

In a preferred embodiment, the rheological additive consists of the swellable phyllosilicate or contains this as the main constituent. In this case, “main constituent” means that the swellable phyllosilicate makes up more than half of the rheological additive, i.e. more than 50 wt. %, in particular 60 to 80 wt. %.

The rheological additive is particularly preferably montmorillonite or contains this as the main constituent, for example bentonite.

The amount of the rheological additive to be used depends substantially on the amount of water, a person skilled in the art being readily able to select the correct ratio of these constituents and also optional constituents to be used such that the hardener component has the required viscosity and fiowability. The hardener component preferably contains the rheological additive in an amount of 0.15 to 5 wt. %, based on the total weight of the hardener component, is contained.

In an alternative embodiment, the rheological additive can contain further thickeners based on silicas, such as a hydrophilic fumed silica, and/or based on polysaccharides, such as xanthan gum.

The water is contained in such an amount that, depending on the constituents of the hardener component, the wt. % adds up to 100.

The multi-component reaction resin system according to the invention, which is formulated in particular as a two-component system, is particularly suitable for use with thread-forming screws.

Accordingly, the invention also relates to the use of the reaction resin system with thread-forming screws in holes. The holes can be recesses of natural or non-natural origin, i.e.

cracks, crevices, boreholes and the like. These are typically boreholes, in particular boreholes in various substrates, in particular mineral substrates, such as those based on concrete, aerated concrete, brickwork, limestone, sandstone, natural stone, glass and the like, and metal substrates such as those made of steel.

The multi-component reaction resin system according to the invention is characterized by a low viscosity of the component containing this additive and an increased storage stability of the component compared to embodiments in which the proportion of radically curable compound that carries hydroxyl groups is more than 10 wt. %, based on the total amount of the radically curable compound.

In the embodiments described below, the quantities (wt. %) in each case relate to the individual components, i.e. the resin component and the hardener component, unless otherwise stated. The actual amounts are such that the wt. % of the particular component add up to 100.

In a first preferred embodiment of the reaction resin system according to the invention, the resin component contains:
at least one radically curable compound, the proportion of radically curable compound that carries hydroxyl groups being at most 10 wt. %, preferably at most 5 wt. %, particularly preferably at most 1 wt. % of the total amount of radically curable compound, and
at least one inorganic filler that has hydrophilic properties, and the hardener component contains:
at least one hardener, which is a solid peroxide;
water.

In a preferred aspect of this first embodiment, the solid peroxide is suspended in the water. In a preferred aspect of this first embodiment, the peroxide is dissolved or particularly preferably suspended in the water. In a further preferred aspect of this first embodiment, the resin component contains:
85 to 99.99 wt. %, preferably 90 to 99.9 wt. %, particularly preferably 93 to 99 wt. % of the at least one radically curable compound, the proportion of radically curable compound that carries hydroxyl groups being at most 10 wt. %, preferably at most 5 wt. %, particularly preferably at most 1 wt. % of the total amount of the radically curable compound, and
0.01 to 15 wt. %, preferably 0.1 to 10 wt. %, particularly preferably 1 to 7 wt. % of the at least one inorganic filler having hydrophilic properties, and the hardener component contains:
2 to 50 wt. %, preferably 5 to 45 wt. %, particularly preferably 10 to 40 wt. %, of the at least one hardener, which is a peroxide, and
50 to 98 wt. %, preferably 55 to 95 wt. %, particularly preferably 60 to 90 wt. % of water.

In a further, second preferred embodiment, the resin component contains:
as a radically curable compound, a reaction resin mixture consisting of at least one reaction resin and a reactive diluent, the proportion of radically curable compound that carries hydroxyl groups in the mixture (i.e. total amount of the radically curable compound) being at most 10 wt. %, preferably at most 5 wt. %, particularly preferably at most 1 wt. %;
at least one inorganic filler having hydrophilic properties, and and the hardener component contains:
at least one peroxide as a hardener and
water.

In a preferred aspect of this second embodiment, the peroxide is dissolved or particularly preferably suspended in the water. In a further preferred aspect of this second embodiment, the resin component contains:
85 to 99.99 wt. %, preferably 90 to 99.9 wt. %, particularly preferably 93 to 99 wt. % of a mixture, the reaction resin mixture, consisting of 0 to 99.9 wt. %, preferably 20 to 80 wt. %, based on the total weight of the mixture, of the at least one reaction resin and 0 to 99.99 wt. %, preferably 80 to 20 wt. %, based on the total weight of the mixture, of the at least one reactive diluent as a radically curable compound, the proportion of radically curable compound that carries hydroxyl groups being at most 10 wt. %, preferably at most 5 wt. %, particularly preferably at most 1 wt. % and
0.01 to 15 wt. %, preferably 0.1 to 10 wt. %, particularly preferably 1 to 7 wt. % of the at least one inorganic filler having hydrophilic properties, and the hardener component contains:
2 to 50 wt. %, preferably 5 to 45 wt. %, particularly preferably 10 to 40 wt. %, of the at least one peroxide as a hardener and
50 to 98 wt. %, preferably 55 to 95 wt. %, particularly preferably 60 to 90 wt. % of water.

In a more preferred, third embodiment, the resin component contains:
as a radically curable compound, a reaction resin mixture consisting of at least one reaction resin and a reactive diluent, the proportion of radically curable compound that carries hydroxyl groups being at most 10 wt. %, preferably at most 5 wt. %, particularly preferably at most 1 wt. % of the total amount of radically curable compound,
at least one inorganic filler having hydrophilic properties
at least one accelerator and
at least one inhibitor,
   and the hardener component contains:
at least one peroxide as a hardener,
water and
at least one rheological additive.

In a preferred aspect of this third embodiment, the peroxide is dissolved or particularly preferably suspended in the water. In a further preferred aspect of this third embodiment, the resin component contains:
85 to 99.99 wt. %, preferably 90 to 99.9 wt. %, particularly preferably 93 to 99 wt. % of a mixture, the reaction resin mixture, consisting of 0 to 99.9 wt. %, preferably 20 to 80 wt. %, based on the total weight of the mixture, of the at least one reaction resin and 0 to 99.99 wt. %, preferably 80 to 20 wt. %, based on the total weight of the mixture, of the at least one reactive diluent as a radically curable compound, the proportion of radically curable compound that carries hydroxyl groups being at most 10 wt. %, preferably at most 5 wt. %, particularly preferably at most 1 wt. % of the total amount of the radically curable compound,
0.001 to 5 wt. %, preferably 0.01 to 3 wt. %, more preferably 0.1 to 1 wt. % of the at least one inorganic filler having hydrophilic properties
0.01 to 10 wt. %, preferably 0.5 to 5 wt. %, more preferably 1 to 3 wt. % of the at least one accelerator and
0.001 to 5 wt. %, preferably 0.01 to 3 wt. %, more preferably 0.1 to 1 wt. % of the at least one inhibitor,
   and the hardener component contains:
2 to 50 wt. %, preferably 5 to 45 wt. %, particularly preferably 10 to 40 wt. % of the at least one peroxide as a hardener and
50 to 98 wt. %, preferably 55 to 95 wt. %, particularly preferably 60 to 90 wt. % of water,
0.001 to 5 wt. %, preferably 0.01 to 3 wt. %, more preferably 0.1 to 1 wt. % of the at least one swellable phyllosilicate.

In a particularly preferred, fourth embodiment, the resin component contains:
as a radically curable compound, a reaction resin mixture consisting of at least one reaction resin selected from compounds based on urethane (meth)acrylate, epoxy (meth)acrylate, based on a (meth)acrylate of an alkoxylated bisphenol, and consisting of at least one reactive diluent based on (meth)acrylate, the proportion of radically curable compound that carries hydroxyl groups being at most 10 wt. %, preferably at most 5 wt. %, particularly preferably at most 1 wt. %,
at least one inorganic filler having hydrophilic properties, in particular a silica,
at least one accelerator and
at least one inhibitor,
   and the hardener component contains:
at least one peroxide, in particular a diacyl peroxide,
water and
at least one rheological additive based on a phyllosilicate.

In a preferred aspect of this fourth embodiment, the peroxide is dissolved or particularly preferably suspended in the water. In a further preferred aspect of this fourth embodiment, the reaction resin system contains the constituents in the amounts specified in the third aspect.

In a very particularly preferred, fifth embodiment, the resin component contains:
as a radically curable compound, a reaction resin mixture consisting of at least one reaction resin based on urethane (meth)acrylate and at least one reactive diluent based on (meth)acrylate, with the proviso that the (meth)acrylic ester is not a hydroxyalkyl (meth)acrylic ester, the proportion of radically curable compound that carries hydroxyl groups being at most 10 wt. %, preferably at most 5 wt. %, particularly preferably at most 1 wt. %,
at least one inorganic filler having hydrophilic properties, in particular hydrophilic fumed silica,
at least one accelerator and
at least one inhibitor,
   and the hardener component contains:
at least one peroxide, in particular dibenzoyl peroxide,
water and
at least one rheological additive based on a swellable phyllosilicate.

In a very particularly preferred, sixth embodiment, the resin component contains:
as a radically curable compound, a reaction resin mixture consisting of at least one reaction resin based on urethane (meth)acrylate and at least one reactive diluent based on (meth)acrylate, with the proviso that the (meth)acrylic ester is not a hydroxyalkyl (meth)acrylic ester, the proportion of radically curable compound that carries hydroxyl groups being at most 10 wt. %, preferably at most 5 wt. %, particularly preferably at most 1 wt. %,
at least one inorganic filler having hydrophilic properties, in particular hydrophilic fumed silica,
at least one accelerator and
at least one inhibitor,
   and the hardener component contains:
at least one peroxide, in particular dibenzoyl peroxide,
water and
at least one rheological additive based on a swellable phyllosilicate.

In a preferred aspect of this sixth embodiment, the peroxide is dissolved or particularly preferably suspended in the water. In a further preferred aspect of this sixth embodiment, the reaction resin system contains the constituents in the amounts specified in the third aspect.

In a further, seventh embodiment, the resin component contains:
a reaction resin mixture consisting of at least one reaction resin as a radically curable compound, and at least one reactive diluent as a radically curable compound,
at least one inorganic filler having hydrophilic properties,
at least one hydraulically setting or polycondensable inorganic compound,
at least one accelerator and
at least one inhibitor,
   and the hardener component contains:
at least one hardener.
water and
at least one rheological additive.

In a preferred aspect of this seventh embodiment, the peroxide is dissolved or particularly preferably suspended in the water. In a further preferred aspect of this sixth embodiment, the reaction resin system contains the constituents specified in more detail in the fourth and/or fifth aspect in the amounts specified in the third aspect.

In each of the aforementioned preferred embodiments, both the resin component and the hardener component can each independently contain 0 to 30 wt. %, preferably 0.5 to 25 wt. %, particularly preferably 2 to 20 wt. % of additives, such as emulsifiers, antifreeze agent, buffers and/or rheological additives, etc.

According to the invention, the reaction resin system, in which, according to the invention, the rheological additive having hydrophilic properties is used, is used with thread-forming screws in holes. The holes can be recesses of natural or non-natural origin, i.e. cracks, crevices, boreholes and the like. These are typically boreholes, in particular boreholes in various substrates, in particular mineral substrates, such as those based on concrete, aerated concrete, brickwork, limestone, sandstone, natural stone, glass and the like, and metal substrates such as those made of steel.

The reaction resin system, in which, according to the invention, a rheological additive having hydrophilic properties is used, is characterized by a low viscosity of the resin component containing this additive but a high viscosity of the mixture consisting of the resin component and the hardener component, compared to embodiments which do not contain the rheological additive used or to embodiments having other rheological additives which do not have hydrophilic properties.

The invention is explained in greater detail in the following with reference to a number of examples and comparative examples. All examples support the scope of the claims. However, the invention is not limited to the specific embodiments shown in the examples.

### EXAMPLES

### List of the Constituents Used in the Examples and References (Explanation of Abbreviations) as Well as Their Trade Names and Sources of Supply:

### Resin Components:

UMA-1 urethane methacrylate-HPMA, produced as described in Example 1a from EP 2 838 949 61, as a result of which a mixture with a ratio of urethane methacrylate:HPMA of 65:35 is obtained;
UMA-2 urethane methacrylate-BDDMA, produced analogously to Example 1a from EP 2 838 949 61, wherein instead of the described 688 g HPMA, a mixture of 344 g HPMA and 344 g
BDDMA was used, as a result of which a mixture with a ratio of urethane methacrylate:BDDMA of 65:35 is obtained with a remainder of approximately 1 wt. % HPMA;
HPMA hydroxypropyl methacrylate, from Inchem (CAS number: 27813-02-1)
BDDMA VISIOMER® BDDMA, 1,4-butanediol dimethacrylate, from Evonik Performance Materials GmbH (CAS number: 2082 7)
DIPPT diisopropanol-p-toluidine; from BASF (CAS number: 38668-4-3)
tBBK 4-tort-butylpyrocatechol, from RHODIA Operations (CAS number: 98-29-3)
Aerosil® 200 hydrophilic fumed silica, from Evonik (CAS number: 112945-52-5; specific surface area 200 m²/g; average particle size
0.2-0.3 μm (aggregates))

### Hardener Component:

BP20SAQ dibenzoyl peroxide 20%, suspension in water, unbuffered; from United Initiators (94-36-0)
Optigel CK activated phyllosilicate (bentonite); from BYK-Chemie GmbH (specific density 2.6 g/cm³, bulk density 550-750 kg/m³, moisture content 10% ±2%)

### Examples 1 to 4

To determine the influence of the content of compounds containing hydroxyl groups on the storage stability, the following resin components were prepared in the amounts shown in Table 1 and their viscosity was measured after preparation and after storage. For this purpose, the urethane methacrylate-HPMA mixture or the urethane methacrylate-BDDMA mixture, the HPMA or the BDDMA, DIPPT, tBBK and Aerosil® 200 were stirred in the dissolver at 2,000 rpm and a pressure of 80 mbar for 8 minutes.

The viscosity measurements were carried out on a Haake RS 600 rheometer from Thermo Fisher Scientific Inc, at a shear rate of 150/s. A cone/plate measuring system having a diameter of 20 mm (cone C20/01°, Ti) and an angle of 1° was used; measuring temperature 23° C.

The resin components were heated to the specified temperature of 23° C. in advance. The sample was removed using a disposable Pasteur pipette and applied to the plate of the rheometer. After setting the gap, the temperature is controlled again for 30 seconds and the measurement is started. The viscosity is evaluated at the shear rate of 150/s. The results of the measurements are shown in Table 1.

TABLE 1
Composition of example formulations 1 to 4

| | Example 1 | | | |
|---|---|---|---|---|
| | (Comparison) | Example 2 | Example 3 | Example 4 |
| | [wt. %] | | | |
| UMA-1 | 47.59 | | | |
| UMA-2 | | 48.11 | 47.60 | 47.10 |
| HPMA | 14.28 | 1.00 | 1.00 | 1.00 |
| BDDMA | | 46.68 | 48.20 | 45.71 |
| DIPPT | 1.16 | 1.19 | 1.18 | 1.17 |
| tBBK | 0.02 | 0.02 | 0.02 | 0.02 |
| Aerosil ® 200 | 6.00 | 3.00 | 4.00 | 5.00 |

| | |
|---|---|
| | Viscosity |
| Storage | [mPa · s] |

| | | | | |
|---|---|---|---|---|
| Freshly prepared | 718 | 182 | 383 | 774 |
| 3 months at 25° C. | 386 | | | |
| 3 months at 40° C. | 397 | | | |
| 4 months at 40° C. | | 157 | 385 | 977 |

Example 1, the comparative example, showed the desired flowability at the beginning of storage and the mixture was stable immediately after mixing the two components. After storage of example formulation 1, however, a mixture consisting of this together with a hardener formulation was no longer stable.

Examples 2 to 4, each containing only 1 wt. % of HPMA, were used to determine the optimal Aerosil content. Example 2 was identified as optimal. Although example formulations 3 and 4 had lost some of their flowability, they could be mixed well with a liquid hardener formulation and the mixtures were stable.

This clearly shows that due to the strong reduction in the proportion of HPMA and thus of compounds containing hydroxyl groups, the compounds were able to maintain their storage stability.

### Examples 5 to 8

To determine the influence of the content of compounds containing hydroxyl groups on the storage stability, resin components were prepared with the compositions shown in Table 2. For this purpose, the urethane methacrylate-BDDMA mixture (UMA-2), which still contains 1 wt. % of HPMA due to the production process, the HPMA, the BDDMA, the DiPpT, the tBBK and the Aerosil® 200 were stirred in the dissolver at 2,000 rpm and a pressure of 80 mbar for 8 minutes in the amounts shown in Table 2.

Samples of the formulations were each bottled and stored for 1 day, 1 week, 3 weeks, 6 weeks, 8 weeks, 10 weeks, 12 weeks, 14 weeks and 16 weeks. After storage, the condition of the resin components was determined.

The dynamic viscosity of the respective stored resin components was also determined. The viscosity measurements were carried out on a Haake RS 600 rheometer from Thermo Fisher Scientific Inc. at a shear rate of 150/s. A cone/plate measuring system having a diameter of 20 mm (cone C20/01°, Ti) and an angle of 1° was used; measuring temperature 23° C.

The resin components were heated to the specified temperature of 23° C. in advance. The sample was removed using a disposable Pasteur pipette and applied to the plate of the rheometer. After setting the gap, the temperature is controlled again for 30 seconds and the measurement is started. The viscosity is evaluated at the shear rate of 150/s. The results are reported in Table 3.

In addition, the effect of storage on a mixture with a hardener component was examined.

For this purpose, 15 g of resin component was placed in a SpeedMixer can (150 ml), 6 g of hardener component was added and the can was sealed. Then the two components were mixed within 2 seconds by shaking. The stability of the mixture was then assessed visually by means of a mouth stack, by observing how easily the compound flows from the spatula when it is held at an angle of approx. 45°.

TABLE 2
Composition of example formulations
5 to 8, with increasing HPMA content

| | Example 5 | Example 6 | Example 7 | Example 8 |
|---|---|---|---|---|
| | [wt. %] | | | |
| UMA-2 | 49.11 | 49.11 | 49.11 | 49.11 |
| HPMA | | 1.00 | 2.00 | 3.00 |
| BDDMA | 46.68 | 45.68 | 44.68 | 43.68 |
| DIPPT | 1.19 | 1.19 | 1.19 | 1.19 |
| tBBK | 0.08 | 0.02 | 0.08 | 0.02 |
| Aerosil ® 200 | 3.00 | 3.00 | 3.00 | 3.00 |
| Proportion of | 1.00 | 2.00 | 3.00 | 4.00 |
| HPMA | | | | |

TABLE 3
Results of the viscosity measurements and the observation of the consistency of the compositions of example formulations 5 to 8

| | Proportion | | | | |
|---|---|---|---|---|---|
| | of HPMA | Example 5 | Example 6 | Example 7 | Example 8 |
| | [wt. %] | 1 | 2 | 3 | 4 |
| Freshly prepared | Dynamic viscosity | 292.6 | 286.5 | 268.7 | 275.0 |
| | [mPa · s] | | | | |
| | Resin component | slightly thickened, | slightly thickened, | slightly thickened, | slightly thickened, |
| | consistency | flowable | flowable | flowable | flowable |
| Storage for 1 week | Dynamic viscosity | 156.2 | 143.9 | 133.2 | 129.4 |
| at +40° C. | [mPa · s] | | | | |
| | Resin component | thickened, flowable | thickened, flowable | thickened, flowable | slightly thickened, |
| | consistency | | | | flowable |
| Storage for 2 weeks | Dynamic viscosity | 234.7 | 232.5 | 214.4 | 183.2 |
| at +40° C. | [mPa · s] | | | | |
| | Resin component | quite heavily thickened, | quite heavily thickened, | thickened, flowable, | slightly thickened, |
| | consistency | but flowable | but flowable | thinner layer on top | flowable, thinner |
| | | | | | layer on top |
| Storage for 4 weeks | Dynamic viscosity | 245.6 | 241.0 | 233.0 | 203.0 |
| at +40° C. | [mPa · s] | | | | |
| | Resin component | very heavily thickened, | heavily thickened, | quite heavily thickened, | thickened, |
| | consistency | liquid settled on top, | still flowable, | flowable, | good flowability |
| | | no longer flowable | liquid settled on top | liquid settled on top | |
| | Curing | stable mixture with slight | stable mixture with slight | stable mixture with slight | stable mixture with |
| | | streaks, but | streaks, but | streaks, but | slight streaks, but |
| | | homogeneous curing | homogeneous curing | homogeneous curing | homogeneous curing |
| Storage for 6 weeks | Dynamic viscosity | 224.7 | 238.7 | 236.0 | 207.0 |
| at +40° C. | [mPa · s] | | | | |
| | Resin component | very heavily thickened, | heavily thickened, still | thickened, flowable, | slightly thickened, |
| | consistency | no longer flowable, | flowable, | sedimentation, approx. | good flowability, |
| | | liquid has settled on top | sedimentation? Approx. | 3 mm of liquid settled | sedimentation, approx. |
| | | | 2 mm of liquid has | on top | 1 cm of clear liquid |
| | | | settled on top. | | on top |
| | Curing | good thickening effect, | good thickening effect, | good thickening effect, | good thickening effect, |
| | | good and fast curing | good and fast curing | good and fast curing | good and fast curing |
| Storage for 8 weeks | Dynamic viscosity | 205.0 | 225.0 | 225.0 | 219.0 |
| at +40° C. | [mPa · s] | | | | |
| | Resin component | Sedimentation, gel-like, | Sedimentation, gel-like, | Sedimentation, gel-like, | slightly thickened, |
| | consistency | inner core, liquid settled | inner core, liquid settled | inner core, a lot of liquid | good flowability, |
| | | on the outside, approx. | on the outside, approx. | settled on the outside, | sedimentation, approx. |
| | | 2 mm of liquid on top | 2 mm of liquid on top | approx. 0.5 cm of liquid | 1 cm of clear liquid |
| | | | | on top | on top |
| Storage for 10 weeks | Dynamic viscosity | 174.0 | 223.0 | 197.0 | 171.0 |
| at +40° C. | [mPa · s] | | | | |
| | Resin component | sedimentation, gel-like, | sedimentation, gel-like, | sedimentation, gel-like, | slightly thickened, |
| | consistency | inner core, approx. | inner core, approx. | inner core, approx. | good flowability, |
| | | 2 mm of liquid on top | 2 mm of liquid on top | 0.5 cm of liquid on top | sedimentation, approx. |
| | | | | | 1 cm of liquid on top |
| Storage for 14 weeks | Dynamic viscosity | 129.4 pipette | 126.3 pipette | 128.6 pipette | 92.0 pipette |
| at +40° C. | [mPa · s] | 92.7 spatula | 83.9 spatula | 89.6 spatula | 91.4 spatula |
| | Resin component | heavily thickened, inner | heavily thickened, inner | heavily thickened, inner | slightly thickened resin, |
| | consistency | gel-like core, approx. | gel-like core, approx. | gel-like core, more | good flowability, |
| | | 1 mm of liquid settled | 2 mm of liquid settled | liquid around the core, | approx. 10 mm of clear |
| | | on top | on top | smaller core than with 1 | liquid on top, no gel |
| | | | | or 2% HPMA | core |
| Storage for 16 weeks | Dynamic viscosity | 194.6 | 191.0 | 209.5 | 175.3 |
| at +40° C. | [mPa · s] | | | | |
| | Resin component | heavily thickened gel- | heavily thickened gel- | heavily thickened, inner | slightly thickened resin, |
| | consistency | like core, approx. 1 mm | like core, approx. 2 mm | gel-like core, more | good flowability, |
| | | of liquid settled on | of liquid settled on | liquid around the core, | approx. 12 mm of clear |
| | | top −> no change | top −> no change | smaller core than with 1 | liquid on top, small gel |
| | | | | or 2% HPMA, approx. | core? |
| | | | | 0.5 mm of liquid on | |
| | | | | top −> no change | |
| | Curing | thickening effect after | thickening effect after | thickening effect after | thickening effect after |
| | | mixing, good curing | mixing, good curing | mixing, good curing | mixing, good curing |
| Storage for 20 weeks | Dynamic viscosity | 225.0 | 215.7 | 224.6 | 182.1 |
| at +40° C. | [mPa · s] | | | | |
| | Resin component | heavily thickened gel- | heavily thickened gel- | heavily thickened gel- | slightly thickened resin, |
| | consistency | like core in liquid | like core, approx. 1 cm | like core, approx. 1 cm | good flowability, |
| | | | of liquid on top | of liquid on top | approx. 2 cm of clear |
| | | | | | liquid on top |
| | Curing | thickening effect after | thickening effect after | thickening effect after | thickening effect after |
| | | mixing; good curing | mixing; good curing | mixing; good curing | mixing; good curing |
| Storage for 24 weeks | Dynamic viscosity | 270.7 | 308.8 | 205.1 | 169.9 |
| at +40° C. | [mPa · s] | | | | |
| | Resin component | large gel-like core, | large gel-like core, | gel-like core in liquid | approx. 2 cm of clear |
| | consistency | some liquid outside | slightly more liquid on | | liquid on top, gel-like |
| | | | the outside than with | | sediment of approx. |
| | | | 1% HPMA | | 1 cm on bottom |
| | Curing | Sampling | Sampling | Sampling | Sampling |
| | | in the A comp.: | in the A comp.: | in the A comp.: | in the A comp.: |
| | | on top¹⁾: even slighter | on top: no thickening | on top: even smaller | on top: no thickening |
| | | thickening effect after | effect after mixing | thickening effect after | effect after mixing |
| | | mixing | on bottom: good | mixing, marginal | on bottom: good |
| | | on bottom²⁾: good | thickening of the | on bottom: good | thickening of the |
| | | thickening of the | mixture | thickening of the | mixture |
| | | mixture | both: good curing | mixture | both: good curing |
| | | both: good curing | | both: good curing | |

¹⁾and ²⁾sampling points of the sample vessel

### Examples 9 and 10

In order to determine the upper limit of the content of compounds containing hydroxyl groups, resin components were prepared with the compositions shown in Table 4. For this purpose, the urethane methacrylate-BDDMA mixture, which still contains 1 wt. % of HPMA due to the production process, the BDDMA, the HPMA, the DiPpT, the tBBK and the Aerosil® 200 were stirred in the dissolver at 2,000 rpm and a pressure of 80 mbar for 8 minutes in the amounts shown in Table 4. A composition containing a total of 10 wt. % and a formulation containing a total of 20 wt. % of HPMA were obtained.

TABLE 4
Composition of example formulations 9 and 10

| | |
|---|---|
| Example 9 | Example 10 |

[wt. %]

| | | |
|---|---|---|
| UMA-2 | 49.11 | 49.11 |
| HPMA | 9.00 | 19.00 |
| BDDMA | 37.68 | 27.68 |
| DiPpT | 1.19 | 1.19 |
| tBBK | 0.08 | 0.02 |
| Aerosil ® 200 | | 3 |
| Proportion of | 10 | 20 |
| HPMA | | |
| [wt. %] | | |

Samples of example formulation 9 and example formulation 10 were each bottled and stored for 1 week, 3 weeks, 6 weeks, 8 weeks, 10 weeks, 12 weeks, 14 weeks and 16 weeks. After storage, the condition of the formulations was determined. For this purpose, 15 g of resin component was placed in a SpeedMixer can (150 ml), 6 g of hardener component was added and the can was sealed. Then the two components were mixed within 2 seconds by shaking. The stability of the mixture was then assessed visually by means of a mouth stack, by observing how easily the compound flows from the spatula when it is held at an angle of approx. 45°.

In addition, the stored formulations were each mixed with a hardener formulation composed of 98 wt. % of BP 20 SAQ and 2 wt. % of Optigel OK in order to determine the curing properties after storage.

The results are reported in Table 5. It can be seen from these results that the example formulation is somewhat stable in storage for 9 to 3 weeks, However, after longer storage, sedimentation and impaired curing of the formulation were observed. In the case of example formulation 10, it is already observed after storage for 2 weeks that the formulation increasingly thickened and sedimentation occurred.

TABLE 5
Results of the storage test of the resin components containing 10 wt.
% of HPMA (example 9) and containing 20 wt. % of HPMA (example 10)

| | | Example 9 | Example 10 |
|---|---|---|---|
| | Proportion of HPMA [%] | 10 | 20 |
| 1 day | Resin component | slightly thickened, good | slightly thickened, good |
| | consistency | flowability | flowability |
| | Mixture with hardener | good thickening after | good thickening after |
| | component | mixing, good curing | mixing, good curing |
| 1 week | Resin component | slightly thickened, | slightly thickened, clear, |
| | consistency | clear, except on the | except on the bottom, |
| | | bottom, approx. 2 cm | approx. 1 cm of slightly |
| | | of slightly unclear | unclear bottom layer |
| | | bottom layer | |
| | Mixture with hardener | good thickening after | low level of thickening |
| | component | mixing, good curing | immediately after mixing, |
| | | | the mixture only thickens |
| | | | with increasing curing, |
| | | | good curing |
| 2 weeks | Resin component | slightly thickened, | slightly thickened, clear, |
| | consistency | clear, except approx. | except approx. 1 cm of |
| | | 2 cm of slightly unclear | unclear layer on the |
| | | layer on the bottom | bottom, sharp separation |
| | | | between the layers |
| | Mixture with hardener | even slighter thickening | no thickening effect |
| | component | effect after mixing | immediately after mixing |
| | | | the two components |
| 3 weeks | Resin component | slightly thickened, | slightly thickened, approx. |
| | consistency | approx. 3 cm of clear | 5 cm of clear layer on top, |
| | | layer on top, approx. | approx. 1 cm of unclear |
| | | 2 cm of unclear layer | layer on the bottom |
| | | on the bottom | |
| | Mixture with hardener | marginal | there is no longer any |
| | component | | thickening effect |
| 4 weeks | Resin component | slightly thickened, | slightly thickened, approx. |
| | consistency | approx. 2.5 cm of | 1 cm of “sediment” on the |
| | | “sediment” on the | bottom |
| | | bottom, clear on top | |
| | Mixture with hardener | “on top: still normal, | no test: see 3 weeks |
| | component | slightly smaller | |
| | | thickening effect, | |
| | | on the bottom: normal” | |
| 5 weeks | Resin component | see 4 weeks; | on top: marginal; even |
| | consistency | unchanged | smaller |
| | | | on the bottom: still normal |
| | Mixture with hardener | no test | no test |
| | component | | |

1. A multi-component reaction resin system for use with thread-forming screws, comprising:
a first component, comprising at least one radically curable compound and an inorganic filler, and
a second component, comprising a hardener for the at least one radically curable compound and water
wherein the inorganic filler has hydrophilic properties, and
wherein a proportion of the at least one radically curable compound that carries hydroxyl groups is at most 10 wt. % of a total amount of the at least one radically curable compound.

2. The multi-component reaction resin system according to claim 1, wherein the at least one radically curable compound comprises a reaction resin, a reactive diluent, or a mixture consisting of the reaction resin and the reactive diluent.

3. The multi-component reaction resin system according to claim 2, wherein the at least one radically curable compound or the reaction resin is a compound based on urethane (meth)acrylate, epoxy (meth)acrylate, a (meth)acrylate of an alkoxylated bisphenol, or a further ethylenically unsaturated compound.

4. The multi-component reaction resin system according to claim 2, wherein the reactive diluent is a (meth)acrylic acid ester, with the proviso that the (meth)acrylic acid ester is not a hydroxyalkyl (meth)acrylic acid ester.

5. The multi-component reaction resin system according to claim 4, wherein the (meth)acrylic acid ester is selected from the group consisting of 2-ethylhexyl (meth)acrylate, phenylethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate, acetoacetoxyethyl (meth)acrylate, 3-(meth)acryloyl-oxymethyl-tricylo-5.2.1.0.^{2.6}-decane, 3-(meth)cyclopentadienyl (meth)acrylate, methoxy polyethylene glycol mono(meth)acrylate, trimethylcyclohexyl (meth)acrylate, dicyclopentenyloxyethyl (meth)acrylate, bisphenol A (meth)acrylate, isobornyl (meth)acrylate, decalyl-2-(meth)acrylate, ethanediol-1,2-di(meth)acrylate, propanediol-1,3-di(meth)acrylate, butanediol- 1,2-di(meth)acrylate, butanediol-1,3-di(meth)acrylate, butanediol-1,4-di(meth)acrylate, hexanediol-1,6-di(meth)acrylate, ethylene-, diethylene glycol di(meth)acrylate, oligo- and polyalkylene glycol di(meth)acrylate, PEG200 di(meth)acrylate, alkoxylated tri-, tetra- and pentamethylacrylate, tricyclopentadienyl di(meth)acrylate, novolac epoxy di(meth)acrylate, trimethylolpropane tri(meth)acrylate, di-[(meth)acryloyl-maleoyl]-tricyclo-5.2.1.0.^{2.6}-decane and dicyclopentenyloxyethyl crotonate.

6. The multi-component reaction resin system according to claim 1, wherein the inorganic filler having hydrophilic properties comprises minerals selected from the group consisting of an alkaline earth metal and a salt thereof, bentonite, a carbonate, a silica, silica gel, a salt of alkaline earth metals with silica, and a silicate.

7. The multi-component reaction resin system according to claim 6, characterized in that wherein the inorganic filler is a silicon oxide-based filler.

8. The multi-component reaction resin system according to claim 7, wherein the silicon oxide-based filler comprises a silica.

9. The multi-component reaction resin system according to claim 8, wherein the silica is an amorphous silica selected from the group consisting of colloidal silica, precipitated silica, silica gel, fumed silica, silica smoke, silica glass (quartz glass), silica material (quartz material), and a skeleton of radiolarians and diatoms in a form of diatomaceous earth.

10. The multi-component reaction resin system according to claim 1, wherein the inorganic filler is surface-treated.

11. The multi-component reaction resin system according to claim 1, wherein the at least one radically curable compound is a compound based on urethane (meth)acrylate, epoxy (meth)acrylate, or a further ethylenically unsaturated compound.

12. The multi-component reaction resin system according to claim 1, wherein the hardener is a peroxide.

13. The multi-component reaction resin system according to claim 1, wherein the hardener and the water are in a form of an aqueous suspension.

14. The multi-component reaction resin system according to claim 1, wherein the first component and/or the second component contains, as a further additive, at least one further inorganic or organic additive.

15. The multi-component reaction resin system according to claim 1, wherein the multi-component reaction resin system is a two-component system.

16. The multi-component reaction resin system according to claim 15, it wherein the multi-component reaction resin system is a bag system, ampoule system, or capsule system.

17. A method, comprising:
fastening an anchoring means in a borehole with the multi-component reaction resin system according to claim 1.

18. The method according to claim 17, wherein the anchoring means is a thread-forming screw.

19. The method according to claim 18, wherein the thread-forming screw is a concrete screw.
